(19) United States
(12) Patent Application Publication
(10) Pub. No.: US 2017/0349406 A1
(43) Pub. Date: Dec. 7, 2017

(54) BRAKE ASSEMBLY OF ELEVATOR SYSTEM

(71) Applicants: Juan Antonio ILLAN, Leganes, Madrid (ES); Otis Elevator Company, Farmington, CT (US)

(72) Inventor: Juan Antonio Illan, Madrid (ES)

(21) Appl. No.: 15/534,214

(22) PCT Filed: Dec. 10, 2014
(86) PCT No.: PCT/ES2014/070908

§ 371 Date: Jun. 8, 2017

(51) Int. Cl. B66B 5/02; B66B 9/00; F16D 55/22; B66B 1/32; F16D 121/22

(52) U.S. Cl. CPC B66B 5/02; F16D 55/22; B66B 1/32; B66B 9/00; F16D 2121/22

(57) ABSTRACT

An elevator system (10) is comprised of a car (22), and a shaft (46) operatively connected to the car and configured to rotate for movement of the car through the elevator system. A brake assembly (44) is comprised of a disk (56) connected to and configured to rotate along with the shaft. Movable plates (60, 62) are placed on respective opposite sides of the disk and configured to move axially toward and away from the disk. Electromagnets are configured to respectively move the movable plates away from the disk. Elastic elements (64, 66) are configured to respectively move the movable plates toward the disk. The disk is free to move axially, and is designed to stop the movement of the car by stopping the rotation of the shaft when the rotation of the disk is stopped by friction from contact of the movable plates with the disk when the elastic elements move the movable plates toward the disk.

### BACKGROUND INFORMATION ON THE INVENTION

This invention relates generally to an elevator system, and more specifically to a brake assembly for an elevator system that does not have a machine room.

An elevator system without a conventional machine room is comprised of a car and a counterweight that are located in an elevator shaft. The car and counterweight are configured to move up and down in the elevator shaft, carrying passengers or cargo from one floor to another. The cable (e.g. comprised of numerous round tension cables or flat belts) connects the car and the counterweight to each other. A motorized, non-geared drive unit is located on the upper part of the elevator shaft, and is comprised of a drive pulley that engages the cable (typically by traction) to drive it, and the car and the counterweight are moved as the drive pulley rotates. A controller controls system operation. When a call is made for a desired destination (for example, a floor), the controller sends a signal to the drive unit to raise or lower the car to the floor and then to apply a brake (e.g. a disc brake or a clutch) to the drive unit as the car approaches the floor. The brake has a direct mechanical link to the drive pulley. When an emergency stop is registered, the brake is applied immediately to the drive unit.

More specifically, the brake may be comprised of a stationary element (such as a steel plate) attached to the drive unit, plus a pair of movable steel plates. Two elastic elements (e.g., springs, 0-rings, or a combination thereof) are connected respectively to the movable plates, and an electromagnet (e.g., a coil) is configured to move the movable plates. A disc, which is comprised of a friction liner attached on both sides of the disc, is placed between the fixed plate and the movable plates. The disc is attached to a shaft that rotates with the drive unit when the car is moving, and thus the disc is rotating. The shaft extends in the brake. The coil and, for example, the springs are placed in a housing that is placed on one side of the movable plates, opposite to the fixed plate and the disc.

When braking becomes necessary, it is initiated by deactivating the coil. As a result, a magnetic force that holds the movable plates against the coil disappears, and the springs force the movable plates against the disc, which, in turn, moves against the fixed plate so that the disk is between the fixed plate and the movable plates. This establishes a contact between one lining and both of the movable plates, and the other lining is pressed against the fixed plate. In this way, torque (by means of friction) is generated and applied by the contact, which torque stops the rotation of the disc. Since the disc is attached to the shaft, stoppage is transmitted to the shaft and the drive unit, and stops the movement of the car. When it is necessary for the car to move again, the controller sends a signal and current is sent to the coil to pull the movable plates away from the disc and the fixed plate, allowing rotation of the disc and shaft, and, in turn, allowing movement of the car.

It may be required (e.g., by a regulation or standard) that the brake be redundant so that each movable plate (that is, each brake half) is able to provide an amount of torque to decelerate or halt 100% of a full system load. It may also be required that the complete brake be capable of decelerating 125% of the full load. In a conventional elevator system, the torque applied by each movable plate stops 100% of the full load. The torque of each movable plate is added to that of the other movable plate to establish a total brake torque (i.e., equal to twice the torque of a single movable plate) for 150% of the full load. Thus, the complete brake decelerates with an intensity of greater than 150% of the full load.

### BRIEF DESCRIPTION OF THE INVENTION

According to a non-limitative example of the invention, a brake assembly of an elevator system is provided. The elevator system is comprised of a car and a shaft operatively connected to the car and configured to rotate in order to move the car through the elevator system. The brake assembly is comprised of a disc connected to and configured to rotate with the shaft. A first movable plate and a second movable plate are placed on respective opposite sides of the disc and configured to move axially toward and away from the disc. A first and a second electromagnet are configured to move respectively the movable plates away from the disc. A first and a second elastic element are configured to move respectively the movable plates toward the disc. The disc is free to move axially and is configured to stop the movement of the car by stopping the rotation of the shaft when the rotation of the disc is stopped by friction of the contact of the movable plates with the disc when the elastic elements move the movable plates toward the disc.

### BRIEF DESCRIPTION OF THE DRAWINGS

The subject matter that is considered to be the invention is indicated specifically and claimed distinctly in the claims at the end of the specification. The features, characteristics, and advantages of the invention described above are evident in the following detailed description, together with the attached drawings, in which:

FIG. 1 is a transversal view of a cross section of a non-limitative example of an elevator system without a machine room.

FIG. 2 is a perspective view of a non-limitative example of a drive unit of the elevator system illustrated in FIG. 1.

FIG. 3 is a schematic lateral view of a brake assembly of the drive unit illustrated in FIG. 2, according to a non-limitative example of the invention.

### DETAILED DESCRIPTION OF THE INVENTION

Referring to the drawings, a non-limitative example of an elevator system is indicated in a general manner by 10. Although elevator system is 10 described in this invention as being an elevator system without a machine room (in which a drive unit of the elevator system 10 is located in an elevator shaft rather than in a conventional machine room), it should be easy to see that elevator system 10 may be any suitable type of elevator system. And, although elevator system 10 is described herein as being implemented during power failures and/or emergency stoppages, it should also be easy to see that elevator system 10 may be implemented under any other suitable conditions and with any suitable magnitude and type of deceleration.

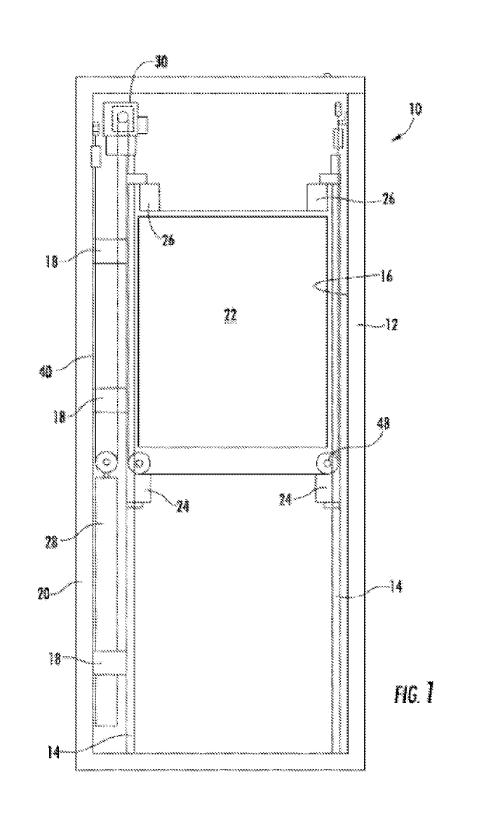

FIG. 1 shows the system for elevator 10. Elevator shaft 12 has at least one car guide rail 14 that is affixed to an inner wall 16 of the elevator shaft 12, and it can be attached to the counterweight supports 18, which, in turn, can be attached to the opposite interior wall 20. In the design, elevator shaft 12 includes two rails 14. Alternatively, the rails 14 may be attached directly to the opposite interior wall 20 or using separate supports (not shown). A car 22 is supported within and configured to move through the elevator shaft 12 along the rails 14, which guide the vertical movement of the car 22 in the elevator shaft 12. The car 22 has guide assemblies 24, 26 placed respectively in a lower part and an upper part of the car 22, to maintain appropriate alignment of the car 22 as it moves along the rails 14. The car 22 is connected to a counterweight 28, which is moved up and down the elevator shaft 12 as the car 22 transports passengers or cargo from one floor to another.

The counterweight supports 18 effectively define a space that extends over the entire height of the elevator shaft 12, for movement of the counterweight 28. The term “counterweight 28” as used in this report, includes a counterweight assembly that may be comprised of various components as should be readily seen by technical expert. The counterweight 28 is moved opposite to the car 22, as is known with a conventional elevator system. The counterweight 28 is guided by counterweight guide rails (not shown) mounted inside the elevator shaft 12.

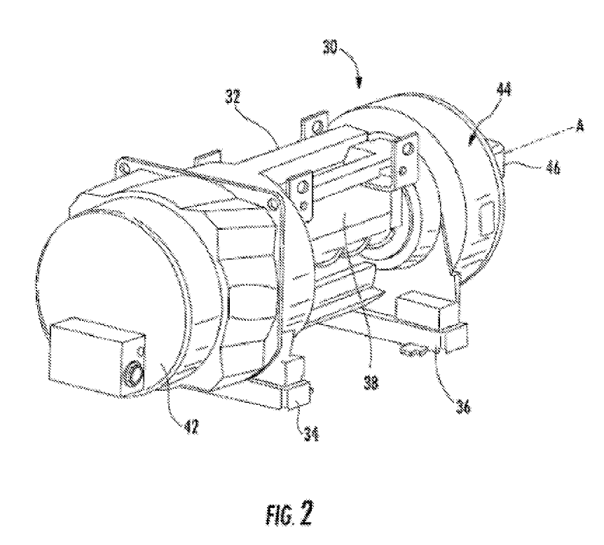

FIG. 2 illustrates a drive unit without gears, according to a non-limitative example of the invention, which drive unit is generally indicated by 30, and is configured to drive the movement of the car 22 through the elevator shaft 12. The drive unit 30 is located in the upper part of the elevator shaft 12. More specifically, the drive unit 30 is placed and supported in an assembly location—such as on a shelf (not shown)—above at least one of the counterweight's guide rails. Supporting the drive unit 30 above the counterweight guide rail(s) eliminates the need for a separate machine room, as required in a conventional elevator system. The elevator system 10 requires much less overhead room in the elevator shaft 12 than do conventional elevator systems, and it eliminates the need for a separate machine room. The configuration of the cable and the placement of the elevator shaft 12 as illustrated in FIG. 1 are only examples, and the information provided in this invention may be used in other configurations of the elevator system 10.

The drive unit 30 is comprised of a longitudinal housing 32 that has a first base 34 and a second base 36. A drive pulley 38 is placed inside the housing 32, which defines many areas (e.g. grooves) for receiving the cable 40 (FIG. 1). The cable 40 may include, for example, several round tension cables 40 or flat traction belts 40. A motor 42 is placed on one end of the drive unit 30, and a disc-type or clutch-type brake assembly, according to a non-limitative example, is generally indicated by 44 and is it is placed at the opposite end of the drive unit 30, which brake assembly is operatively connected to the drive unit 30 and the car 22. The motor 42 is connected to and rotates a shaft 46 around an axis A when the car 22 is moving through the elevator shaft 12. The shaft 46 is also connected to the drive pulley 38 (alternatively, the drive pulley 38 may be an integral part of the shaft 46). The drive pulley 38 also has a direct mechanical connection to the brake assembly 44. The drive pulley 38, the motor 42, the brake assembly 44, and the shaft 46 are all placed around the axis A. The brake assembly 44 is configured to apply a braking force to the drive unit 30 and the car 22 such as through the shaft 46—as described in more detail below.

The car 22 and the counterweight 28 have pulley assemblies 48 (FIG. 1) that cooperate with the cable 40 and the drive unit 30 to raise and lower the car 22. In one aspect of the embodiment, the drive unit 30 is suitable and is sized to be used with flat drive belts 40, and the pulley assemblies 48 are attached to a base of the car 22. However, the pulley assemblies 48 may be mounted at another location on the car 22, or elsewhere in the elevator system 10, as should be readily seen by a technical expert.

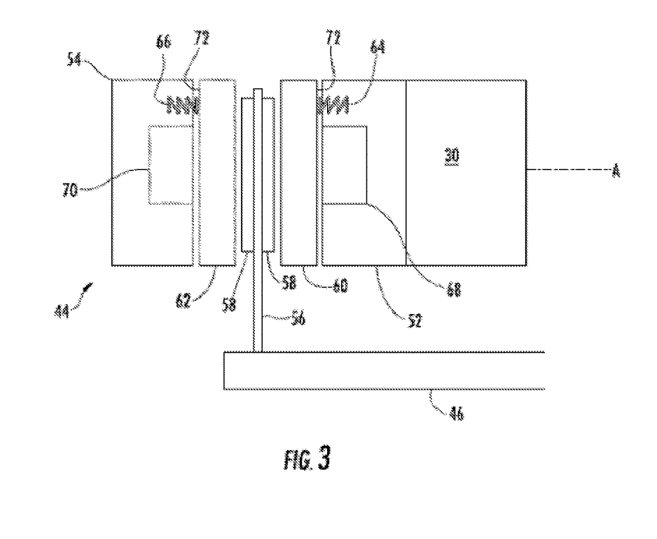

Referring to FIG. 3, the brake assembly 44 is comprised of a first housing 52 and a second housing 54, a disc 56 that includes a friction liner 58 attached to each side of the disc 56, a first and second movable steel plate 60, 62, a first and second elastic element 64, 66, and a first and a second electromagnet 68, 70 (in the form of, for example, coils 68, 70). The housings 52, 54, the disc 56, the movable plates 60, 62, and the coils 68, 70, rotate around the shaft 46. The brake assembly 44 is connected to the shaft 46 through the disc 56, for example, by means of splines (not shown) on the shaft 46 that engage in grooves (not shown) in a center (not shown) of the disc 56. This connection causes the disc 56 to rotate with the shaft 46 and it allows the disc 56 to move axially along the shaft 46. The brake assembly 44 is also secured to a non-rotating part of the drive unit 30, whereby the first housing 52 of the brake assembly 44 is affixed to the drive unit 30 using, for example, bolts (not shown), and affixing the second housing 54 or even the first housing 52 or even the drive unit 30.

More specifically, the movable plates 60, 62 are separated from and placed on respective opposite sides of the disc 56. Each movable plate 60, 62 may be an annular disc or it may be formed of multiple segments. The housings 52, 54 are separated from and placed respectively over the exterior sides 72 of the movable plates 60, 62, and an exterior side of the first housing 52 is affixed to an interior side of the drive unit 30. According to one aspect of the embodiment, the elastic elements 64, 66 are springs 64, 66. The springs 64, 66 are placed inside the corresponding housings 52, 54, and each spring 64, 66 extends outside of the corresponding housing 52, 54 to be attached to the exterior side 72 of the corresponding movable plate 60, 62. Although the springs 64, 66 may have any suitable relationship with the corresponding housings 52, 54, in one aspect of the example the springs 64, 66 are placed, respectively, in the upper regions of the corresponding housings 52, 54. The coils 68, 70 are placed in the corresponding housings 52, 54, and concentric with the shaft 46, and an inner side of each coil 68, 70 is placed flush with an inner side of the corresponding housing 52, 54.

It should be readily seen that the liner 58 can be made of any suitable friction material. It should also be readily seen that each spring 64, 66 may be affixed inside the corresponding housing 52, 54 and/or the corresponding movable plate 60, 62, and each coil 68, 70 may be attached inside the corresponding housing 52, 54, in any suitable manner. It should further be readily seen that the first housing 52 may be affixed to the drive unit 30 in any suitable manner. Additionally, it should be readily seen that the housings 52, 54 may also contain noise-absorbing 0-rings (not shown). In any event, it should be readily seen that the two halves of the brake assembly 44 are mirror images of each other.

Each movable plate 60, 62 is configured to be actioned by two forces—a force of the corresponding spring 64, 66, which moves the movable plate 60, 62 toward the disc 56 (to provide a braking force) and a magnetic field from the corresponding coil 68, 70, which moves the movable plate 60, 62 away from the disc 56. In this regard, the movable plate(s) 60, 62 may have a finishing on them that reduces the likelihood that the corresponding linings 58 will stick to the movable plate(s) 60, 62. It should be readily seen that, although not shown in the drawings, the movement of each movable plate 60, 62 can be guided in bushings (not shown) to ensure that the movement is parallel. The bushings may be constrained axially at one end by the first housing 52 or the drive unit 30, and at the other end by the second housing 54. A controller (not shown) for controlling operation of the elevator system 10 is connected to the drive unit 30 via the wiring (not shown) in the motor 42 and the coils 68, 70. Thus, when a call to a floor is registered, the controller sends drive signals to the drive unit 30 to raise or lower the car 22 to that floor and then to actuate the brake assembly 44 to the drive unit 30 as the car approaches that floor, or when an emergency stop is registered.

In operation of the elevator system 10, to move the car 22 up and down in the elevator shaft 12, the controller sends drive signals through the wiring to the motor 42 to rotate the shaft 46 around the axis A. The rotation of the shaft 46 is transferred to the drive pulley 38, which rotates, and, through traction drives the tension belts 40 to raise or lower the car 22 and the counterweight 28, and, depending on how the drive signals are sent to the motor 42, they cause the motor 42 to rotate the shaft 46. Meanwhile, the controller also sends current through the wiring to the coils 68, 70 to produce a magnetic field that causes the movable plates 60, 62 to move axially toward the corresponding housings 52, 54. Movement of the movable plates 60, 62 away from the disc 56 allows the disc 56 to rotate with the shaft 46.

When a power loss is experienced, and/or emergency braking is desired, the controller stops sending the current to the coils 68, 70 and the movable plates 60, 62 are then released and secured to move axially toward the disc 56 due to the force exerted on the movable plates 60, 62 by the corresponding springs 64, 66. When the springs 64, 66 move the movable plates 60, 62 axially away from the corresponding housings 52, 54, a movable plate 60, 62 pushes the disc 56 into contact with the other movable plate 60, 62. The friction resulting from the contact of the corresponding liners 58 with the movable plates 60, 62 stops the rotating disc 56. This rotation stoppage is transferred to the shaft 46, the drive pulley 38, and the drive belts 40, causing detection of the movement of the car 22 up or down in the elevator shaft 12 to be stopped.

The “mirror” design of the brake assembly 44 allows a torque amount of a movable plate 60, 62 (that is, half of the brake assembly 44) to be applied to a respective side of the disc 56 such that the disc 56 is free to move axially (i.e., toward the other movable plate 60, 62). Thus, the respective torques of the plates 60, 62 are not added to each other to establish a total amount of torque of the brake assembly 44. Rather, the total amount of torque is equal to the amount of torque of one single movable plate 60, 62. Therefore, each movable plate 60, 62 is configured to provide a sufficient amount of torque to decelerate in accordance with about 125% of the total load of the elevator system 10. However, since the respective torques of the movable plates 60, 62 are not added together, the brake assembly 44 as a whole decelerates in accordance with the same percentage of the full load. Thus, the total torque amount remains at about 125% of the full load.

With the elevator system 10, the torques of the two movable plates 60, 62 (that is, both halves of the brake assembly 44) are not added to each other, and thus the deceleration capability of the brake assembly 44 is only around 125% of the full load. This causes less torque resulting in smaller decelerations of the elevator system 10 during power failures and/or emergency stops, which may minimize or even eliminate passenger discomfort and resulting passenger complaints. More specifically, the total amount of torque of the brake assembly 44 may be reduced to about 25% above that of a conventional elevator system. This lower permissible torque value is particularly relevant in areas where power failures are frequent.

Compared to a conventional elevator system, the elevator system 10 allows a lower initial torque design for the complete brake assembly 44. Also, the elevator system 10 allows the coils 68, 70 to be smaller. In addition, the elevator system 10 allows a distance between the movable plates 60, 62 (that is, a total air gap) that is substantially identical to the distance between the movable plate and the fixed plate in a conventional elevator system. Furthermore, at high speed the elevator system 10 allows the cable 40 to slide less in an emergency stoppage.

Although the invention has been described in detail in connection with just a few examples, it can be readily seen that the invention is not limited to the examples described. Rather, the invention may be modified to incorporate any number of variations, alterations, substitutions, or equivalent placements that have not been described up to this point, but which are in accordance with the spirit and scope of the invention. Additionally, although several non-limitative examples of the invention have been described, it should be understood that aspects of the invention may include only some of the examples described. Accordingly, the invention should not be regarded as limited by the foregoing description; rather it is limited only by the scope of the attached claims.

1. An elevator system comprised of:
An elevator shaft;
At least one guide rail for the car that is attached in the elevator shaft;
A car supported inside the elevator shaft and configured to move through that shaft along the rail;
A drive unit configured to action the movement of the car through the elevator shaft;
A shaft that defines an axis and is connected to the drive unit and rotated by it when the car is moving through the elevator shaft; and
A brake assembly operatively connected to the drive unit and the car, configured to apply a braking force to the drive unit, which brake assembly is comprised of the following:
A disc that is connected to the shaft and configured to rotate with it when the car is moving through the elevator shaft;
A first and a second movable plate placed on respective opposite sides of the disc that are configured to move axially toward and away from the disc;
A first and a second electromagnet configured to move respectively the movable plates away from the disc; and
A first and second elastic element that are configured to move respectively, the movable plates toward the disc, the disc that is free to be moved axially, and to stop the movement of the car by stopping the rotation of the shaft when the rotation of the disc is stopped by friction of the contact of the movable plates with the disc when the elastic elements move the movable plates toward the disc.

2. The elevator system of claim 1, in which the disc has a friction liner attached to each side of the disc, and the friction of the contact of the movable plates with the corresponding liners stops the rotation of the disc.

3. The elevator system of claim 1, in which the brake assembly is also comprised of a first housing and second housing that rotate around the shaft and are separated from and placed over the respective exterior sides of the movable plates, an exterior side of the first housing is affixed to an interior side of the drive unit, and the second housing is affixed to either the first housing or the drive unit.

4. The elevator system of claim 3, in which the elastic elements are placed inside the corresponding housings, and each of the elastic elements extends outside the corresponding housing, to be attached to the exterior side of the corresponding movable plate.

5. The elevator system of claim 1, in which the elastic elements include springs.

6. The elevator system of claim 3, in which the electromagnets are placed inside the corresponding housings, and concentric to the shaft, and the interior side of each of the electromagnets is placed flush with the interior side of the corresponding housing.

7. The elevator system of claim 1, in which the electromagnets include coils.

8. A brake assembly for an elevator system comprised of a car and a shaft operatively connected to the car and configured to rotate to move the car through the elevator system, which brake assembly comprises:
A disc connected to and configured to rotate with the shaft;
A first and a second movable plate placed on respective opposite sides of the disc and configured to move axially toward and away from the disc;
A first and a second electromagnet configured to move, respectively, the plates away from the disc; and
A first and a second elastic element configured to move, respectively, the movable plates toward the disc, the disc that is free to move axially and configured to stop the movement of the car by stopping rotation of the shaft when the rotation of the disc is stopped by friction of the contact of the movable plates with the disc when the elastic elements move the movable plates toward the disc.

9. The brake assembly of claim 8, in which the disc is comprised of a friction liner attached to each side of the disc, and the contact friction of the movable plates with the corresponding liners stops rotation of the disc.

10. The brake assembly of claim 8, in which the brake assembly is also comprised of a first housing and a second housing that rotate around the shaft and separated from and placed, respectively, on the exterior sides of the movable plates, an exterior side of the first housing is affixed to the interior side of the drive unit, and the second housing is attached to either the first housing or the drive unit.

11. The brake assembly of claim 10, in which the elastic elements are placed in the corresponding housings, and each of the elastic elements extends outside of the corresponding housing to be attached to the exterior side of the corresponding movable plate.

12. The brake assembly of claim 8, in which the elastic elements are comprised of springs.

13. The brake assembly of claim 10, in which the electromagnets are placed in the corresponding housings and concentric to the shaft, and the interior side of each of the electromagnets is placed flush with an interior side of the corresponding housing.

14. The brake assembly of claim 8, in which the electromagnets include coils.
